(19) United States
(12) Patent Application Publication
(10) Pub. No.: US 2023/0229939 A1
(43) Pub. Date: Jul. 20, 2023

(54) METHOD AND DEVICE FOR ASCERTAINING A FUSION OF PREDICTIONS RELATING TO SENSOR SIGNALS

(71) Applicant: Robert Bosch GmbH, Stuttgart (DE)

(72) Inventor: Christoph-Nikolas Straehle, Weil Der Stadt (DE)

(21) Appl. No.: 18/152,960

(22) Filed: Jan. 11, 2023

(30) Foreign Application Priority Data
Jan. 18, 2022 (DE) 10 2022 200 547.3

(51) Int. Cl. G06N 5/022; G06N 7/01

(52) U.S. Cl. CPC G06N 5/022; G06N 7/01

(57) ABSTRACT

A computer-implemented method for ascertaining a fusion of a plurality of predictions, the predictions of the plurality of predictions in each case characterizing a classification and/or a regression result relating to a sensor signal. The fusion is ascertained based on a product of probabilities of the respective classifications and/or regression results and based on an a priori probability of the fusion, the a priori probability for ascertaining the fusion entering into a power, the exponent of the power being the number of elements in the plurality of predictions minus 1.

### CROSS REFERENCE

The present application claims the benefit under 35 U.S.C. § 119 of German Patent Application No. DE 10 2022 200 547.3 filed on Jan. 18, 2022, which is expressly incorporated herein in its entirety.

### FIELD

Autonomously or partly autonomously acting systems such as robots or self-driving vehicles require the use of sensors to ascertain a surrounding environment of the corresponding system. In particular, in this way the sensors can contribute to the system being able to virtually reconstruct the environment, and in this way can carry out further measures such as trajectory planning.

Typically, here it is advantageous if, instead of one sensor, a plurality of sensors are used that perceive the environment of the system. The plurality of sensors can be configured such that a plurality of sensors of the same type, for example a plurality of cameras, are used, or sensors of different types are used, such as camera, lidar, and ultrasonic sensors.

This poses the problem of how the individual signals of the sensors or predictions relating to the different signals can be suitably combined, i.e., fused. There are various approaches to such fusion, for example early fusion or late fusion.

Advantageously, the present invention enables a novel method for late fusion.

### SUMMARY

In a first aspect, the present invention relates to a computer-implemented method for ascertaining a fusion of a plurality of predictions, the predictions of the plurality of predictions in each case characterizing a classification and/or a regression result relating to a sensor signal. According to an example embodiment of the present invention, the fusion is ascertained based on a product of probabilities of the respective classifications and/or regression results and based on an a priori probability of the fusion, the a priori probability for ascertaining the fusion entering into a power, the exponent of the power being the number of elements in the plurality of predictions minus 1.

The fusion can be understood as the result of a combination of the predictions of the plurality of predictions. The predictions can characterize classifications and/or regression results. A regression result can be understood as a result of a regression analysis. In particular, a regression result can include one or more real values, for example a scalar or a vector value.

In particular, a sensor signal can be provided by an optical sensor, such as a camera, a LIDAR sensor, a radar system, an ultrasonic sensor, or a thermal camera. For sensor signals of optical sensors, a prediction can characterize in particular a classification of the entire sensor signal and/or an object detection relating to the sensor signal and/or a semantic segmentation of the sensor signal.

A sensor signal can also be provided by an acoustic sensor, such as a microphone. For sensor signals from acoustic sensors, a prediction can characterize in particular a classification of the entire sensor signal and/or an event detection and/or a speech recognition.

A sensor signal can also be provided by a sensor that is set up to ascertain physical variables other than those described above, for example, a velocity and/or a pressure and/or a voltage and/or a current strength.

The predictions of the plurality of predictions may in particular characterize probabilities or probability densities. For example, the sensor signals may be optical signals from different images, and the predictions may characterize a probability with which objects from an environment of the sensor are imaged in particular regions of the respective optical signals. For a region, the fusion can then for example fuse the different predictions relating to this region for different sensor signals.

$$p ( y \vert x ) = \frac{{\prod }_{i = 1}^{N} p ( y \vert {x}_{i} )}{{p ( y )}^{N - 1}} \cdot \frac{{\prod }_{i = 1}^{N} p ( {x}_{i} )}{p ( x )} p ( y \vert {x}_{i} ) i p ( y ) p ( y \vert x ) y y y {x}_{i} i i i i x$$

In preferred specific embodiments of the present invention, the fusion can be ascertained based on a first equation

$$p ( y \vert x ) = \frac{{\prod }_{i = 1}^{N} p ( y \vert {x}_{i} )}{{p ( y )}^{N - 1}} \cdot \frac{{\prod }_{i = 1}^{N} p ( {x}_{i} )}{p ( x )} p ( y \vert {x}_{i} ) i p ( y ) p ( y \vert x ) y y y {x}_{i} i i i i x$$

where is the -th element of the plurality of predictions and is the a priori probability. In the equation, denotes a probability or probability density of fusion with respect to the event . Here can be for example be a class of a classification. In the object recognition, can for example be the class “Object is in region” or “Object is not in region.” In the equation, further characterizes a -th sensor signal, which corresponds with the -th prediction of the plurality of predictions. In other words, the -th prediction was ascertained based on the -th sensor signal. In the equation, is the plurality of sensor signals, for example in the form of a vector.

$$p ( y \vert x ) = \frac{{\prod }_{i = 1}^{N} p ( y \vert {x}_{i} )}{{p ( y )}^{N - 1}} \cdot \frac{{\prod }_{i = 1}^{N} p ( {x}_{i} )}{p ( x )} p ( y \vert {x}_{i} ) i p ( y ) p ( y \vert x ) y y y {x}_{i} i i i i x$$

The a posteriori probability p(y|xᵢ) can be ascertained in particular by a machine learning system, for example a neural network. In a preferred embodiment of the method, different machine learning systems can be used to ascertain the plurality of predictions in each case; for example, a separate machine learning system may be used for each prediction to be ascertained. This can also be understood as meaning that a special machine learning system exists for each of the different sensor signals, which system is designed to ascertain a corresponding sensor signal and to ascertain a prediction of the plurality of predictions.

In various specific embodiments of the present invention, the a priori probability of fusion can be ascertained based on a relative frequency with respect to a training data set.

For this purpose, it can be ascertained how often the event y occurs in sensor signals of the training data set, and from this a relative frequency can be ascertained. The relative frequency can then be used as an a priori probability.

In alternative specific embodiments of the present invention, it is also possible to ascertain the a priori probability using a model, where the model is ascertained based on the training data set.

For example, a normal distribution or a Gaussian mixed distribution model can be used as a model, and the parameters of the model can be adapted to the training data set, for example based on maximum likelihood estimation. Other statistical or machine learning models can also be chosen as a model for the a priori probability, for example a variational autoencoder or a normalizing flow.

The a priori probabilities or a priori probability density of the sensor signals p(xᵢ) and/or the a priori composite probability or the a priori composite probability density p(x) can also be ascertained based on a model. For example, the training data set can also be used to train a variational autoencoder or a normalizing flow. In this way, statistical models for the p(xᵢ) and/or p(x) can be ascertained.

log p(y|x)=(Σᵢ₌₁^{N} log p(y|xᵢ))−(N−1)·log p(y)+(Σᵢ₌₁^{N} log p(xᵢ))−log p(x)

The fusion can also be ascertained based on equivalent formulations of the above equation. For example, it may be advantageous to ascertain the fusion as a log-likelihood or log-likelihood density. The calculation of the logarithmic probability or the logarithmic probability density has, for example, the advantage of simplifying the calculation of the individual terms of the first equation. In this case, the first equation would transform to

log p(y|x)=(Σᵢ₌₁^{N} log p (y|xᵢ))−(N−1)·log p(y)+log p(xᵢ))−log p(x).

$$p ( y \vert x ) = \frac{{\prod }_{i = 1}^{N} p ( y \vert {x}_{i} )}{{p ( y )}^{N - 1}}$$

It is also possible that the absolute value of the probability can be neglected. In this case the first equation simplifies to

$$p ( y \vert x ) = \frac{{\prod }_{i = 1}^{N} p ( y \vert {x}_{i} )}{{p ( y )}^{N - 1}}$$

log p(y|x)=(Σᵢ₌₁^{N} log p(y|xᵢ))−(N−1)·log p(y)

or, in its logarithmic form, to

$$log p ( y \vert x ) = ( {\sum }_{i = 1}^{N} log p ( y \vert {x}_{i} ) ) - ( N - 1 ) \cdot log p ( y ) .$$

Preferably, in addition it is possible in the various specific embodiments of the present invention for one prediction of the plurality of predictions to be left out of account for ascertaining the fusion if the prediction deviates from the other predictions of the plurality of predictions beyond a predefined threshold.

For example, it is possible to investigate what the smallest numerical distance is between a prediction and the other predictions of the plurality of predictions. If this smallest distance is greater than or equal to the predefined threshold value, then the prediction can be left out of account for the ascertaining of the fusion. Advantageously, in this way predictions that falsify the fusion can be excluded. This increases the accuracy of the fusion.

In the following, exemplary embodiments of the present invention are described in detail with reference to the figures.

### BRIEF DESCRIPTION OF THE DRAWINGS

FIG. 1 schematically shows a design of a control system for controlling an actuator, according to an example embodiment of the present invention.

FIG. 2 schematically shows an exemplary embodiment for controlling an at least partially autonomous robot, according to the present invention.

FIG. 3 schematically shows an exemplary embodiment for controlling a manufacturing system, according to an example embodiment of the present invention.

FIG. 4 schematically shows an exemplary embodiment for controlling a personal assistant, according to the present invention.

FIG. 5 schematically shows an exemplary embodiment of a medical analysis device, according to the present invention.

### DETAILED DESCRIPTION OF EXAMPLE EMBODIMENTS

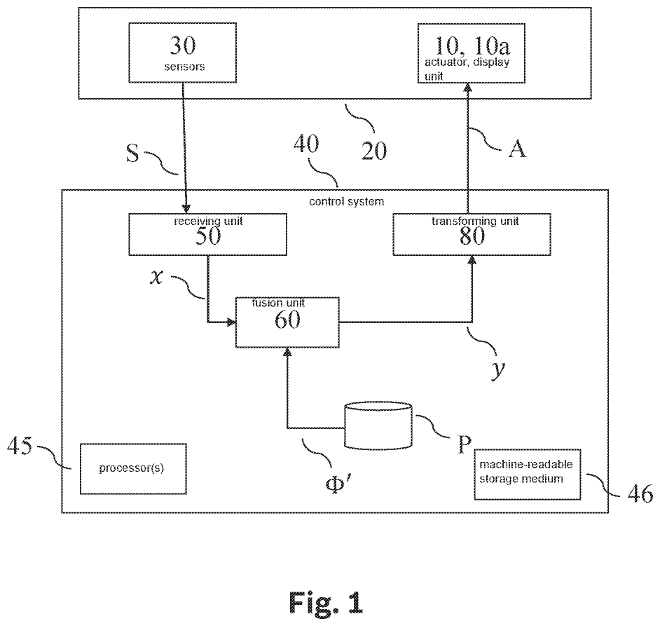

FIG. 1 shows an actuator (10) in its environment (20) in interaction with a control system (40). At preferably regular time intervals, the environment (20) is acquired by a plurality of sensors (30), in particular a plurality of optical sensors such as camera sensors. The sensors collectively ascertain a plurality of sensor signals (S), and the plurality of sensor signals are transmitted to the control system (40). Thus, the control system (40) receives the plurality of sensor signals (S). The control system (40) ascertains control signals (A) therefrom, which are transmitted to the actuator (10).

The control system (40) receives the plurality of sensor signals (S) from the sensor (30) in an optional receiving unit (50), which converts the plurality of sensor signals (S) into a plurality of input signals (x) (alternatively, one sensor signal each can also be directly taken as an input signal). For example, an input signal can be a section or further processing of a sensor signal (S). In other words, an input signal is ascertained as a function of a sensor signal in each case. Preferably, an input signal is ascertained for each sensor signal. The plurality of input signals (x) is then supplied to a fusion unit (60).

The fusion unit (60) is preferably parameterized by parameters (Φ), which are stored in a parameter memory (P) and are provided by this memory. The parameters may be, for example, weights of one or more neural networks that the fusion unit (60) includes.

The fusion unit (60) ascertains, for the input signals (x), preferably for each input signal of the input signals (x), a probability or a probability density with respect to an event, the event with the highest probability or highest probability density being outputted as a fusion by the fusion unit (60). For example, an event can be a class from a plurality of classes or a real number. The probability with respect to the event can be understood as an a posteriori probability. In particular, a machine learning system can be used to ascertain the probability of the event. The machine learning system can be for example a neural network. Preferably, for each input signal of the plurality of input signals (x), the fusion unit can include a respective machine learning system designed to determine the a posteriori probability based on the input signal.

$$p ( y \vert x ) = \frac{{\prod }_{i = 1}^{N} p ( y \vert {x}_{i} )}{{p ( y )}^{N - 1}} \cdot \frac{{\prod }_{i = 1}^{N} p ( {x}_{i} )}{p ( x )} y$$

In particular, the fusion unit can ascertain the fusion based on the equation

$$p ( y \vert x ) = \frac{{\prod }_{i = 1}^{N} p ( y \vert {x}_{i} )}{{p ( y )}^{N - 1}} \cdot \frac{{\prod }_{i = 1}^{N} p ( {x}_{i} )}{p ( x )} y$$

The event here is a possible result of the fusion, such that at the end the event with the highest probability or probability density is outputted as fusion.

$$p ( y \vert x ) = \frac{{\prod }_{i = 1}^{N} p ( y \vert {x}_{i} )}{{p ( y )}^{N - 1}} \cdot \frac{{\prod }_{i = 1}^{N} p ( {x}_{i} )}{p ( x )} y$$

From the input signals (x), the fusion unit (60) ascertains a fusion (y). The fusion (y) is fed to an optional transforming unit (80), which ascertains control signals (A) therefrom, which are supplied to the actuator (10) in order to correspondingly control the actuator (10).

The actuator (10) receives the control signals (A), is controlled accordingly, and carries out a corresponding action. The actuator (10) can comprise a (not necessarily structurally integrated) control logic, which ascertains a second control signal from the control signal (A), which second signal is then used to control the actuator (10).

In further specific embodiments, the control system (40) includes the sensors (30). In still further embodiments, the control system (40) alternatively or additionally includes the actuator (10).

In further preferred embodiments, the control system (40) comprises at least one processor (45) and at least one machine-readable storage medium (46) on which instructions are stored that, when executed on the at least one processor (45), cause the control system (40) to carry out the method according to the invention.

In alternative specific embodiments, a display unit (10a) is provided as an alternative or in addition to the actuator (10).

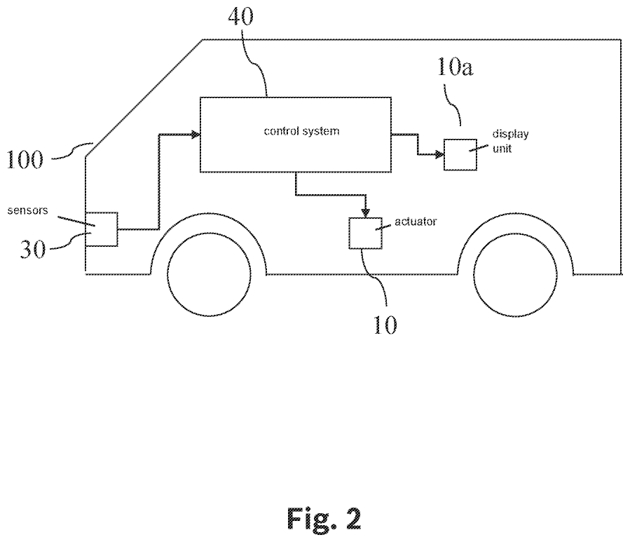

FIG. 2 shows how the control system (40) can be used to control an at least partially autonomous robot, in this case an at least partially autonomous motor vehicle (100).

The sensors (30) may be, for example, a plurality of video sensors preferably situated in the motor vehicle (100). The input signals (x) can be understood as input images in this case.

For example, the fusion unit (60) can be set up to identify recognizable objects in the respective input images, the recognized objects being fused by the fusion unit. For this purpose, the fusion unit (60) may include a plurality of neural networks for object detection, each of which detects objects from the corresponding input signals. Preferably, the neural networks can be designed as detectors for one-shot object detection, the neural networks determining a probability for respective areas of an input image as to whether an object is located in the area or not. The probabilities ascertained in this way can be fused for areas of the input signals that each describe the same locations in the environment (20) of the motor vehicle (100).

Alternatively, it is also possible to classify each of the input images with respect to some item of global information, for example the type of environment (e.g., highway, rural, urban) that the input image shows and/or the type of weather (e.g., rain, snowfall, sunshine) the input image represents. In the specific embodiments, probabilities for the ascertained environment and/or weather type may then be fused, for example.

The actuator (10), which is preferably situated in the motor vehicle (100), can be for example a brake, a drive, or a steering mechanism of the motor vehicle (100). The actuation signal (A) can then be ascertained in such a way that the actuator or actuators (10) are controlled in such a way that the motor vehicle (100) prevents, for example, a collision with the objects identified by the image classifier (60), in particular if the objects belong to certain classes, e.g. pedestrians.

Alternatively or additionally, the control signal (A) can be used to control the display unit (10a), and for example to display the identified objects. It is also possible for the display unit (10a) to be controlled by the control signal (A) in such a way that it emits an optical or acoustic warning signal when it is ascertained that the motor vehicle (100) is threatening to collide with one of the identified objects. The warning by a warning signal can also be provided by a haptic warning signal, for example via a vibration of a steering wheel of the motor vehicle (100).

Alternatively, the at least semi-autonomous robot may be another mobile robot (not shown), such as one that moves by flying, swimming, diving, or stepping. The mobile robot can also be, for example, an at least partially autonomous lawn mower or an at least partially autonomous cleaning robot. In these cases as well, the control signal (A) can be ascertained in such a way that the drive and/or steering of the mobile robot are controlled in such a way that the at least partially autonomous robot avoids, for example, a collision with objects identified by the image classifier (60).

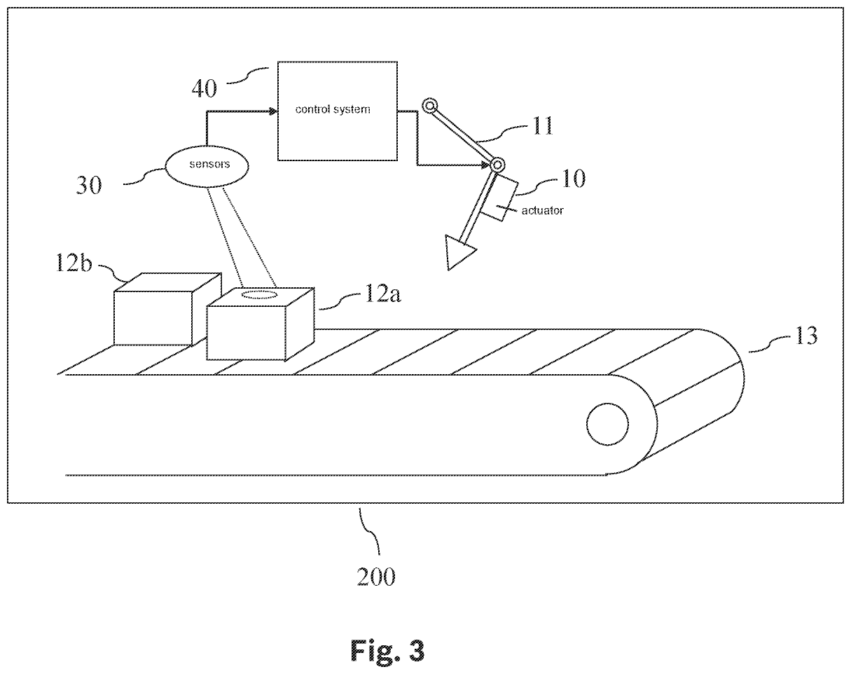

FIG. 3 shows an exemplary embodiment in which the control system (40) is used to control a manufacturing machine (11) of a manufacturing system (200) by controlling an actuator (10) that controls the manufacturing machine (11). The production machine (11) can be for example a machine for punching, sawing, drilling, and/or cutting. It is also possible for the manufacturing machine (11) to be designed to grip a manufactured product (12a, 12b) using a gripper.

The sensors (30) can then be for example video sensors that detect the conveying surface of a conveyor belt (13), where manufactured products (12a, 12b) can be situated on the conveyor belt (13). In this case, the input signals (x) are input images (x). For example, the fusion unit (60) may be set up to ascertain a position of the manufactured products (12a, 12b) on the conveyor belt. The actuator (10) controlling the manufacturing machine (11) can then be controlled as a function of the ascertained positions of the manufactured products (12a, 12b). For example, the actuator (10) can be controlled such that it punches, saws, drills, and/or cuts a manufactured product (12a, 12b) at a predetermined location on the manufactured product (12a, 12b).

Furthermore, it is possible for the fusion unit (60) to be designed to ascertain further properties of a manufactured product (12a, 12b) alternatively to or in addition to the position. In particular, it is possible for the fusion unit (60) to ascertain whether a manufactured product (12a, 12b) is defective and/or damaged. In this case, the actuator (10) can be controlled in such a way that the manufacturing machine (11) rejects a defective and/or damaged manufactured product (12a, 12b). For this purpose, the fusion unit can sort the input signals (x) for example into the classes “ok” and “not ok” respectively, where the “not ok” class characterizes defective and/or damaged manufacturing products.

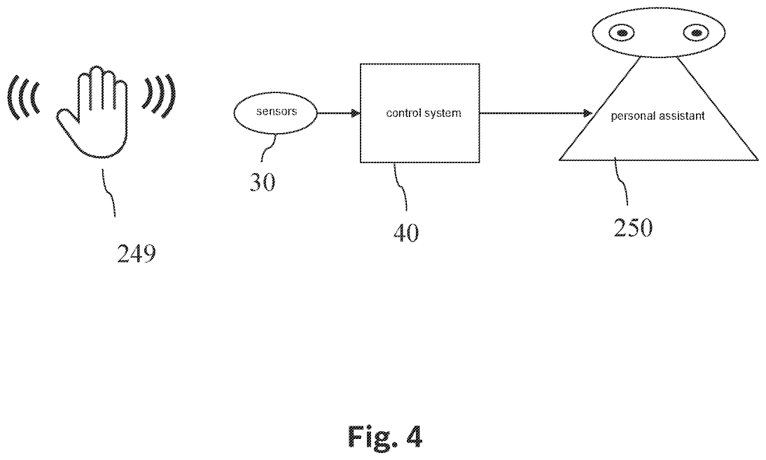

FIG. 4 shows an exemplary embodiment in which the control system (40) is used to control a personal assistant (250). The sensors (30) are preferably optical sensors that receive images of a gesture made by a user (249), such as video sensors and/or thermal imaging cameras.

As a function of the signals from the sensors (30), the control system (40) ascertains an actuation signal (A) of the personal assistant (250), for example in that the fusion unit (60) executes a gesture recognition. This ascertained control signal (A) is then transmitted to the personal assistant (250) and it is thus controlled accordingly. The ascertained actuation signal (A) can in particular be selected in such a way that it corresponds to a presumed desired actuation by the user (249). This presumed desired actuation can be ascertained as a function of the gesture recognized by the fusion unit (60). The control system (40) can then, as a function of the presumed desired actuation, select the actuation signal (A) for transmission to the personal assistant (250) and/or can select the actuation signal (A) for transmission to the personal assistant in accordance with the presumed desired actuation (250).

This corresponding controlling can include, for example, the personal assistant (250) retrieving information from a database and reproducing it in a manner understandable by the user (249).

Instead of the personal assistant (250), a household appliance (not shown), in particular a washing machine, a stove, an oven, a microwave oven, or a dishwasher, may also be provided in order to be controlled accordingly.

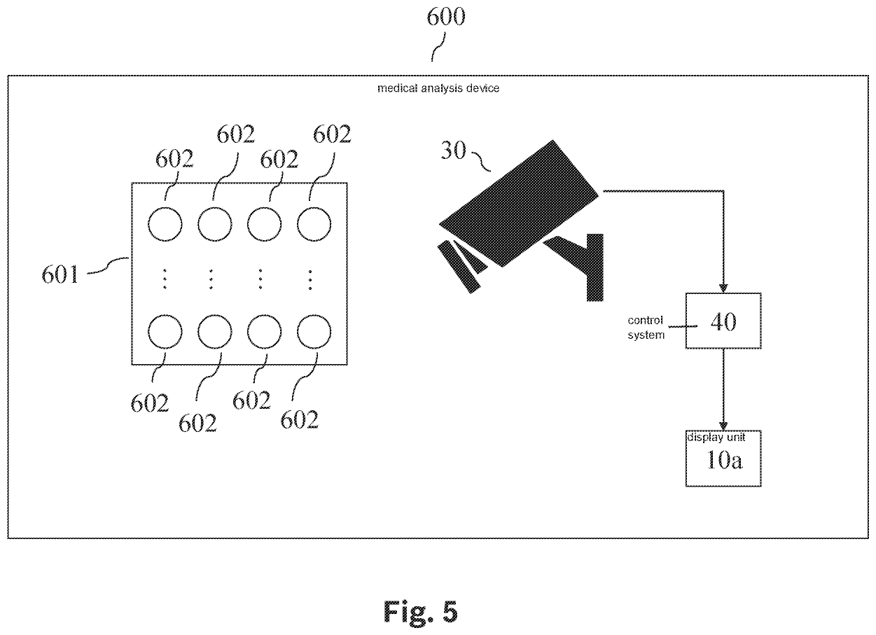

FIG. 5 shows an exemplary embodiment in which the control system (40) controls a medical analysis device (600). A microarray (601) having a plurality of test fields (602) is fed to the analysis device (600), the test fields having been coated with a sample. For example, the sample may originate from a swab of a patient.

The microarray (601) can be a DNA microarray or a protein microarray.

The sensors (30) are set up to record the microarray (601). In particular, optical sensors, preferably video sensors, can be used as sensors (30).

The fusion unit (60) is set up to determine the result of an analysis of the sample based on the images of the microarray (601). In particular, the fusion unit (60) can be set up to classify, based on the images, whether the microarray indicates the presence of a virus in the sample.

The control signal (A) can then be selected such that the result of the classification is displayed on the display device (10a).

The term “computer” covers any device for processing specifiable calculating rules. These calculating rules can be in the form of software, or in the form of hardware, or also in a mixed form of software and hardware.

In general, a plurality can be understood to be indexed, i.e. each element of the plurality is assigned a unique index, preferably by assigning consecutive whole numbers to the elements contained in the plurality. Preferably, if a plurality comprises N elements, where N is the number of elements in the plurality, the elements are assigned the whole numbers from 1 to N.

What is claimed is:

1. A computer-implemented method for ascertaining a fusion (y) of a plurality of predictions, each prediction of the plurality of predictions characterizing a respective classification and/or a regression result relating to a sensor signal, the method comprising:
ascertaining the fusion (y) based on a product of probabilities of the respective classifications and/or regression results and based on an a priori probability of the fusion (y), the a priori probability for ascertaining the fusion being raised to a power, an exponent of the power being a number (N) of elements of the plurality of predictions minus 1.

2. The method as recited in claim 1, wherein the fusion (y) is ascertained based on an equation
$$p ( y \vert x ) = \frac{{\prod }_{i = 1}^{N} p ( y \vert {x}_{i} )}{{p ( y )}^{N - 1}} . \frac{{\prod }_{i = 1}^{N} p ( {x}_{i} )}{p ( x )} ,$$
where p(y|xᵢ) is an i-th element of the plurality of predictions and p(y) is the a priori probability.

3. The method as recited in claim 1, wherein the fusion (y) being ascertained based on an equation
$$p ( y \vert x ) = \frac{{\prod }_{i = 1}^{N} p ( y \vert {x}_{i} )}{{p ( y )}^{N - 1}} ,$$
where p(y|xᵢ) is an i-th element of the plurality of predictions and p(y) is the a priori probability.

4. The method as recited in claim 1, wherein the a priori probability of the fusion (y) is ascertained based on a relative frequency with respect to a training data set.

5. The method as recited in claim 1, wherein the a priori probability is ascertained using a model, the model being ascertained based on a training data set.

6. The method as recited in claim 2, wherein the i-th element of the plurality of predictions being ascertained by a machine learning system.

7. The method as recited in claim 6, wherein the machine learning system includes a neural network.

8. The method as recited in claim 6, wherein the predictions are each ascertained by a different machine learning system and each machine learning system ascertains a prediction for only one sensor signal.

9. The method as recited in claim 1, wherein a prediction of the plurality of predictions is left out of account for ascertaining the fusion when the prediction deviates by greater than a predefined threshold value from the other predictions of the plurality of predictions.

10. A non-transitory machine-readable storage medium on which is stored a computer program for ascertaining a fusion (y) of a plurality of predictions, each prediction of the plurality of predictions characterizing a respective classification and/or a regression result relating to a sensor signal, the computer program, when executed by a processor, causing the processor to perform the following:
ascertaining the fusion (y) based on a product of probabilities of the respective classifications and/or regression results and based on an a priori probability of the fusion (y), the a priori probability for ascertaining the fusion being raised to a power, an exponent of the power being a number (N) of elements of the plurality of predictions minus 1.
